(19) United States
(12) Patent Application Publication
(10) Pub. No.: US 2005/0208826 A1
(43) Pub. Date: Sep. 22, 2005

(54) Multi-pole jack

(75) Inventor: Hiroshi Suzuki, Ibaraki (JP)

Correspondence Address: PEARNE & GORDON LLP, 1801 EAST 9TH STREET, SUITE 1200, CLEVELAND, OH, 44114-3108, US

(73) Assignee: SMK Corporation, Tokyo (JP)

(21) Appl. No.: 11/083,155

(22) Filed: Mar. 17, 2005

(30) Foreign Application Priority Data
Mar. 19, 2004 (JP) 2004-079609

(51) Int. Cl. H01R 9/05

(52) U.S. Cl. 439/578

(57) ABSTRACT

A multi-pole jack includes a jack housing 1 which includes a housing body 1a, and a sleeve portion 1b provided at a distal end of the housing body, a sleeve spring 6 for contact with a sleeve electrode of a plug p inserted in a plug insertion hole 2. The sleeve spring 6 includes an arm-shaped spring piece portion 6c which projects from an upper end of a base portion 6a disposed at the sleeve portion 1b, and is received in an arm receiving groove 1b1, formed in an upper portion of the sleeve portion 1b, and extends therealong to an opposite side portion of the sleeve portion 1b, and a contact portion 6d, formed at a distal end of the arm-shaped spring piece portion, faces the plug insertion hole 2 through an introduction port 1b2 in such a manner that this contact portion can be retracted.

### BACKGROUND OF THE INVENTION

This invention relates to a multi-pole jack used for sending and receiving sound signals and various control signals in a tape recorder, a radio receiver and other audio equipments.

Examples of multi-pole jacks of this kind include a three-pole one, a four-pole one and a six-pole one, and each of these jacks has the construction so as to correspond to a plug having the same number of poles. For example, the four-pole jack, corresponding to the plug having the same number of poles, comprises four kinds of spring-like contact pieces that is, a chip spring, a ring spring and two sleeve springs, and a housing having an insertion hole for the insertion of the plug thereinto, and the spring-like contact pieces are supported in the housing in such a manner that their contact portions face respectively corresponding contact regions in the insertion hole so as to contact the corresponding contact portions of the plug, respectively. The three-pole jack, of course, corresponds to the plug having the same number of poles in which the number of sleeve electrode is smaller by one as compared with the four-pole plug, and a single sleeve spring is provided. The other construction is generally similar to that of the four-pole jack. The six-pole jack, of course, corresponds to the plug having the same number of poles in which two contact rings are additionally provided at the outside of the four-pole plug, and two contact springs are additionally provided at the outer periphery of the housing of the four-pole jack (Patent Literature 1, Patent Literature 2).

In each of these multi-pole jacks, particularly, the plurality of spring-like contact pieces are conventionally provided at a housing body in such a manner that their contact portions face the plug insertion hole, and each spring-like contact piece is extended to locate its contact portion at the contact region (Patent Literature 1, Patent Literature 2). In the three-pole jack, three spring-like contact pieces are provided respectively at three of upper, lower, left and right surfaces of the housing body, and in the jack having four or more poles, four spring-like contact pieces are provided respectively at upper, lower, left and right surfaces of the housing body, and for example, with respect to the chip spring among these springs, its base portion is provide at a front end portion of the housing body, and this chip spring is extended to locate its contact portion at the corresponding contact region in a rear portion of the plug insertion hole, and with respect to the other spring contact pieces, their base portions are provided at a rear end portion of the housing body, and these spring contact pieces are extended forwardly respectively to the corresponding contact regions in the plug insertion hole. In any case, the spring-like contact pieces are all provided in the housing body, and therefore the housing body inevitably becomes large, and has an increased thickness.

There has been proposed a three-pole jack different from the above construction, in which in order to achieve the impedance matching with a plug, a pair of curved spring pieces are provided at a sleeve terminal so as to embrace a sleeve electrode of the plug inserted into a plug insertion hole (Patent Literature 3). This structure includes a terminal body of a gate-shape including a horizontal plate portion and side plate portions depending respectively from opposite ends thereof, and the pair of curved spring pieces which are formed by stamping and raising part of the opposite ends of the horizontal plate portion and part of the opposite side plate portions such that these curved spring pieces have a shape extended respectively from the opposite ends of the horizontal plate portion. The pair of curved spring pieces are bent in such a manner that their distal ends are disposed in close proximity to each other in a butting manner, and as a result the two curved spring pieces jointly form a sleeve contact tubular portion that has a cylindrical shape inside the gate-shaped terminal body.

The gate-shaped terminal body of this sleeve terminal is fitted in a positioning groove formed in an upper portion of a front end portion of the housing body and opposite side portions of the housing body, and the pair of curved spring pieces, provided respectively at the opposite ends of the upper horizontal plate portion, are inserted through respective window holes, open to an upper portion of the positioning groove, into the plug insertion hole inside the terminal body, and are mounted along a peripheral wall of the housing body.

Since the sleeve terminal is constructed as described above, this three-pole jack has an advantage that the impedance matching with the plug can be achieved. However, the housing body becomes large in size, and this jack can not meet the requirement of the thin design of the housing body. Particularly in a four-pole jack, it is difficult to mount a sleeve terminal on a housing body in a manner described above because of the number of spring-like contact pieces used therein.
Patent Literature 1: JP-A-8-138807
Patent Literature 2: JP-A-2002-117946
Patent Literature 3: Japanese Patent No. 3422485

### SUMMARY OF THE INVENTION

It is an object of this invention to provide a multi-pole jack in which a jack housing is formed into a compact size by improving a sleeve spring for electrical connection to a sleeve electrode of a plug inserted in a plug insertion hole.

In order to accomplish the above object, a multi-pole jack of the present invention is characterized by having the following arrangement: (1) A multi-pole jack comprising:
a body;
a sleeve portion that has a plug insertion hole and is disposed at a distal end of the body;
a sleeve spring that includes a base portion that is provided at a side portion of a front portion of the body and a side portion of the sleeve portion, an arm-shaped spring piece portion that projects from a portion of the base portion disposed at the sleeve portion and extends to an upper portion of an opposite side portion of the sleeve portion, and a contact portion that is formed at a distal end of the arm-shaped spring piece portion and faces the plug insertion hole through the upper portion of the opposite side portion so as to contact with a electrode of a plug inserted in the plug insertion hole; and
contact pieces that are disposed at the body so as to contact with other electrodes of the plug inserted in the plug insertion hole.

(2) A multi-pole jack according to (1), wherein the arm-shaped spring piece portion extends from the base portion through an arm receiving groove that is formed from an upper portion of the sleeve portion to the upper portion of the opposite side portion of the sleeve portion in a peripheral direction of the sleeve portion and the contact portion, formed at the distal end of the arm-shaped spring piece portion, projects into the plug insertion hole through an introduction port open to the upper portion of the opposite side portion in a manner that the contact portion can be resiliently retracted.

(3) A multi-pole jack comprising:
a body;
a sleeve portion that has a plug insertion hole and is disposed at a distal end of the body; and
a sleeve spring that includes a base portion that extends between the body and the sleeve portion, an arm-shaped spring piece portion that projects from a portion of the base portion disposed at the sleeve portion and extends in a peripheral direction of the sleeve portion, a contact portion that faces the plug insertion hole so as to contact with a plug inserted in the plug insertion hole in an insertion direction and is formed at a distal end of the arm-shaped spring piece portion.

(4) A multi-pole jack according to (3), wherein the sleeve portion includes a terminal that projects from a portion of the base portion disposed at the body in a direction substantially perpendicular to the insertion direction.

(5) A multi-pole jack according to (4), wherein the terminal is projected from a portion of the body adjacent to the sleeve portion.

(6) A multi-pole jack according to (3), wherein the arm-shaped spring piece portion is disposed in an arm receiving groove formed at the sleeve portion.

(7) A multi-pole jack according to (3), wherein an introduction port is opposed to a portion of the sleeve portion at which the base portion is disposed, and the contact portion faces the plug insertion hole through the introduction port.

(8) A multi-pole jack according to (3), wherein the contact portion has a semi-spherical projection and bulges toward a sleeve electrode of the plug.

(9) A multi-pole jack according to (3), wherein the contact portion can be resiliently retracted.

(10) A multi-pole jack according to (3) further comprising contact pieces that are disposed at the body so as to contact with other electrodes of the inserted plug.

(11) A multi-pole jack according to (3) further comprising a second sleeve spring disposed at the body so that the portion of the base portion disposed at the body is aligned to the second sleeve spring in the peripheral direction.

According to the above aspects, the arm-shaped spring piece portion which is the movable portion of the sleeve spring and the contact portion formed at the distal end thereof are provided in the sleeve portion where the other spring-like contact pieces are not provided. Therefore, the sleeve spring can be easily mounted without interference with the other spring-like contact pieces, and on the other hand the number of the elements, forming the housing body, is reduced, so that the housing body can be formed into a compact design.

The contact portion, which faces the plug insertion hole, need to be resiliently retracted when this contact portion contacts the plug inserted into the plug insertion hole in the jack. The arm-shaped spring piece portion, having this contact portion formed at the distal end thereof, need to have a sufficient length to ensure this resilient retraction. This movable portion projects from the side portion of the sleeve portion, and extends to the upper portion of the opposite side portion thereof, and with this construction the required length of the arm-shaped spring piece portion can be easily obtained.

Moreover, the arm-shaped spring piece portion is received in the arm receiving groove formed in the upper portion of the sleeve portion in the peripheral direction thereof, and therefore particularly the dimension of the jack housing in the direction of its thickness can be prevented from increasing, and the compact and thin design thereof can be achieved. In this construction, when the contact portion is slightly retracted upon contact with the plug inserted into the plug insertion hole, the arm-shaped spring piece portion can make the corresponding retracting movement in the arm-receiving groove, and there is no fear that the arm-shaped spring piece portion interferes with external nearby articles.

### BRIEF DESCRIPTION OF THE DRAWING

FIG. 1A is a front-elevational view of a preferred embodiment of a jack of the invention, FIG. 1B is a rear view thereof, FIG. 1C is a left side-elevational view thereof, FIG. 1D is a right side-elevational view thereof, FIG. 1E is a plan view thereof, and FIG. 1F is a bottom view thereof.

FIG. 2A is a cross-sectional view taken along the line A-A of FIG. 1D, FIG. 2B is a cross-sectional view taken along the line B-B of FIG. 1E, FIG. 2C is a cross-sectional view taken along the line C-C of FIG. 1F, and FIG. 2D is a cross-sectional view taken along the line D-D of FIG. 1D.

FIG. 3A is a front-elevational view of a sleeve spring of the embodiment, FIG. 3B is a left side-elevational view thereof, FIG. 3C is a right side-elevational view thereof, FIG. 3D is a plan view thereof, FIG. 3E is a bottom view thereof, and FIG. 3F is a cross-sectional view taken along the line E-E of FIG. 3B.

FIG. 4A is a front-elevational view of a second sleeve spring of the embodiment, FIG. 4B is a right side-elevational view thereof, and FIG. 4C is a bottom view thereof.

FIG. 5A is a front-elevational view of a ring spring of the invention, FIG. 5B is a left side-elevational view thereof, FIG. 5C is a right side-elevational view thereof, FIG. 5D is a bottom view thereof, and FIG. 5E is a cross-sectional view taken along the line F-F of FIG. 5B.

FIG. 6A is a front-elevational view of a chip spring of the embodiment, FIG. 6B is a right side-elevational view thereof, and FIG. 6C is a bottom view thereof.

### DETAIL DESCRIPTION OF PREFERRED EMBODIMENTS

The present invention is directed to a multi-pole jack basically constituted by a jack housing which includes a housing body, a tubular sleeve portion disposed at a distal end of the housing body, a plug insertion hole open to a distal end of the sleeve portion, and spring-like contact pieces including a sleeve spring having respective contact portions for contact respectively with corresponding electrodes of the plug inserted in the plug insertion hole, and
wherein the sleeve spring includes a base portion provided at a side portion of a front portion of the housing body and a side portion of the sleeve portion, an arm-shaped spring piece portion which projects from that portion of the base portion disposed at the sleeve portion, and extends to an upper portion of an opposite side portion of the sleeve portion, and the contact portion which is formed at a distal end of the arm-shaped spring piece portion, and faces the plug insertion hole through the opposite side portion.

The invention can be applied to any suitable multi-pole jack which includes a tubular sleeve portion which is provided at a distal end of a housing body, and has a plug insertion hole open to the sleeve portion. The invention can be applied to any suitable multi-pole jack with a plurality of poles which includes at least a sleeve spring among spring-like contact pieces for contact with a sleeve electrode of a plug within a plug insertion hole. The invention can be applied not only to a three-pole or a four-pole jack but also to a six-pole jack having two contact springs provided on an outer periphery of a housing in so far as the conditions for spring-like contact pieces, disposed in a plug insertion hole, are the same.

The most important condition of application of the invention relates to the spring-like contact pieces each having its contact portion that faces the plug insertion hole. In view of this, the invention can be suitably applied to a three-pole or a four-pole jack, and above all the invention can be most suitably applied to a four-pole jack which includes many spring-like contact pieces arranged in a complicated manner, and can not be easily formed into a compact design.

The spring-like contact pieces mean all kinds of contact piece members which are made of a spring material, and are inserted in the plug insertion hole, and can contact corresponding electrodes of the plug, respectively. Each spring-like contact piece includes a portion for mounting at a housing and an electrode for contact with the plug, and optionally includes a terminal, a contact portion, an arm-shaped spring piece portion, etc. More specifically, a chip spring having a contact portion for contact with a chip electrode of the plug, a ring spring having a contact portion for contact with a ring electrode, and a sleeve spring, having a contact portion for contact with a sleeve electrode, are referred to as such spring-like contact pieces, and in the case where a second sleeve electrode is formed between the sleeve electrode and the ring electrode, a second sleeve spring for contact with this second sleeve electrode is also called such spring-like contact piece.

A feature of the present invention resides in the sleeve spring among the spring-like contact pieces, and in the case where the chip spring and the ring spring and further the second sleeve spring are used, each of these springs including the second sleeve spring can have a construction generally similar to the conventional construction.

As described above, the sleeve spring basically includes the base portion, the arm-shaped spring piece portion projecting from the base portion, and the contact portion formed at the distal end of this arm-shaped spring piece portion, and this sleeve spring is formed into an integral construction, using an electrically-conductive spring material.

As described above, the base portion is provided at the side portion of the front portion of the housing body and the side portion of the sleeve portion. A suitable slit or the like can be formed in the housing body and the sleeve portion, and the base portion can be provided in the slit or the like. The base portion can be fixed to the slit or the like, for example, by stamping and raising a part of the base portion to form a fixing tongue or the like and then by pressing this fixing tongue against a side surface of the slit. Preferably, a terminal extends from vicinity of a lower end portion of that portion of the base portion disposed at the housing body. This terminal is, of course, formed integrally with the base portion.

The arm-shaped spring piece portion projects from that portion of the base portion disposed at the sleeve portion, and extends to an upper portion of an opposite side portion of the sleeve portion along the periphery of the sleeve portion, and the contact portion, formed at the distal end of the arm-shaped spring piece portion, faces the plug insertion hole. Preferably, an arm receiving groove is formed in the upper portion of the sleeve portion in the peripheral direction, and the arm-shaped spring piece portion is received in this groove, and extends therealong to the upper portion of the opposite side portion of the sleeve portion. Preferably, an introduction port, communicating with the plug insertion hole, is formed in the upper portion of the opposite portion of the arm receiving groove, and the contact portion, formed at the distal end of the arm-shaped spring piece portion, faces the plug insertion hole through this introduction port in such a manner that this contact portion can be resiliently retracted.

The contact portion is formed at the distal end of the arm-shaped spring piece portion as described above, and can contact the sleeve electrode of the plug to be electrically connected thereto. The contact portion can have any suitable construction suited for this purpose. For example, the contact portion can be defined by a semi-spherical projection which is formed at the distal end of the arm-shaped spring piece portion, and bulges toward the sleeve electrode of the plug.

Therefore, in the multi-pole jack of the invention, when the plug, having the corresponding number of poles, is inserted into the plug insertion hole in this jack, the contact portions of the chip spring and ring spring and also the second sleeve spring if this is provided are moved in accordance with their respective constructions, and contact the chip electrode disposed at the distal end of the plug, the secondly-disposed ring electrode and the thirdly-disposed second sleeve electrode, respectively, and further the contact portion of the sleeve spring contacts the sleeve electrode disposed at the proximal end portion of the plug, and these electrical connections which are the basic function of the jack can be satisfactorily effected.

When the plug is thus inserted into the plug insertion hole, the contact portion of the sleeve spring is pushed outwardly by the abutting portion of the plug, and therefore is retracted. This contact portion is formed at the distal end of the arm-shaped spring piece portion extending from the base portion thereof, and this arm-shaped spring piece portion has a sufficient length to extend from the upper portion of one side portion of the sleeve portion to the upper portion of the other side portion thereof, and therefore the retracting movement is resiliently carried out satisfactorily. This sleeve spring is formed of a spring material having a suitable resiliency, so that the contact portion can contact the sleeve electrode of the plug with a suitable spring pressure.

When the plug is inserted into the plug insertion hole to retract the contact portion, the arm-shaped spring piece portion is also retracted outwardly, and when the plug is removed from the plug insertion hole, the arm-shaped spring piece portion is returned by its spring force, thereby restoring the contact portion into its original position. Although the arm-shaped spring piece portion is thus slightly moved radially outwardly and inwardly of the sleeve portion, this movement is small, and therefore there is no fear that the arm-shaped spring piece portion interferes with external nearby articles because of this movement. When the arm receiving groove is formed in the sleeve portion, and the arm-shaped spring piece portion is received in this groove, the above fear is further reduced.

In the multi-pole jack of the invention, the arm-shaped spring piece portion of the sleeve spring, as well the contact portion at the distal end thereof, is provided at the sleeve portion of the jack housing, so that the number of the elements, provided at the housing body, is reduced. Therefore, the dimension of the housing body in the direction of its thickness or in the direction of its width is reduced, so that the compact design can be achieved. When the arm-shaped spring piece portion of the sleeve spring is received in the arm receiving groove formed in the upper portion of the sleeve portion in the peripheral direction, the more compact and thinner design of the jack housing can be achieved.

This embodiment of the invention is directed to a four-pole jack.

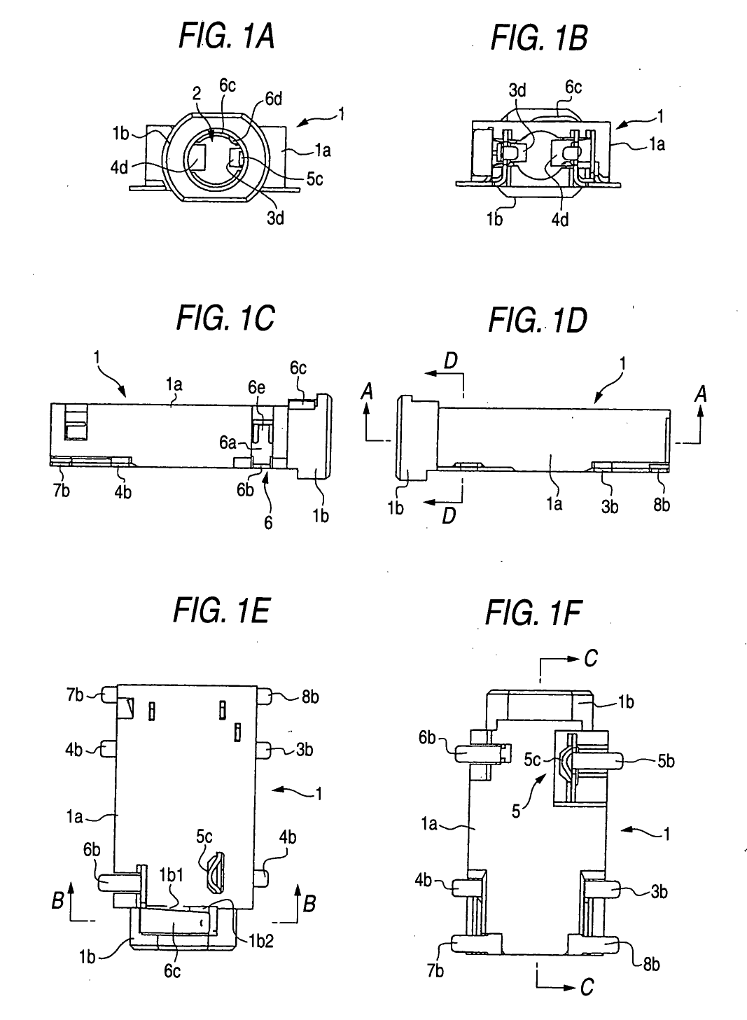

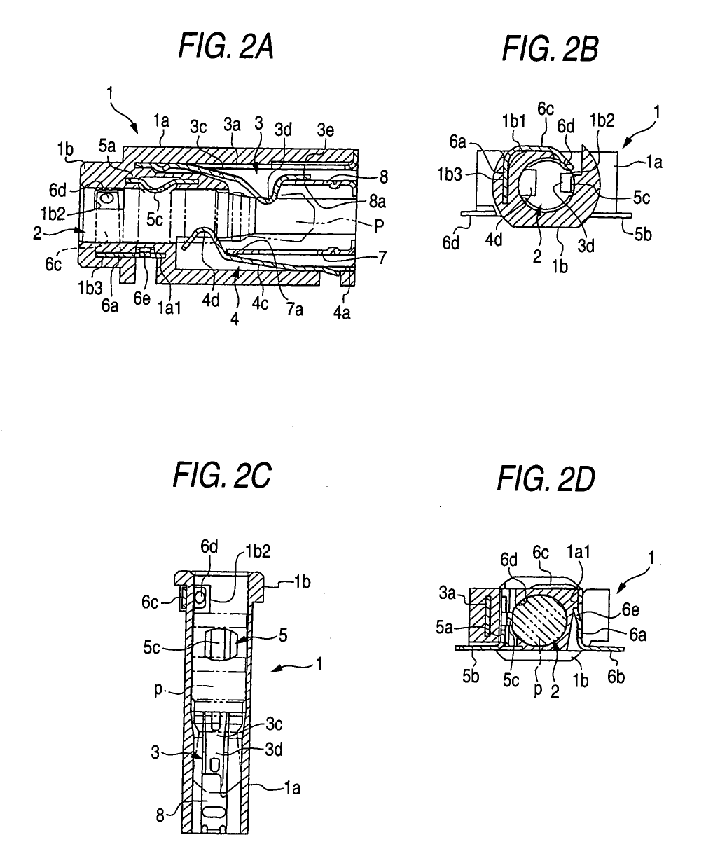

As shown in FIGS. 1A to 1F and 2A to 2D, the four-pole jack of this embodiment comprises a jack housing 1, a chip spring 3, a ring spring 4, a second sleeve spring 5, and a sleeve spring 6, these springs having their respective contact portions 3d, 4d, 5c and 6d faced a plug insertion hole 2 formed in the jack housing 1.

As shown in FIGS. 1A to 1F, the jack housing 1 is a constituent element including a housing body 1a of a generally rectangular parallelepiped shape and a tubular sleeve portion 1b disposed in a projecting manner at a distal end thereof. This jack housing is, of course, made of an insulative material. A distal end portion of the sleeve portion 1b has a larger outer diameter, and the plug insertion hole 2 is open to the distal end of this sleeve portion 1b so that a plug p can be inserted into and removed from the housing body through this opening.

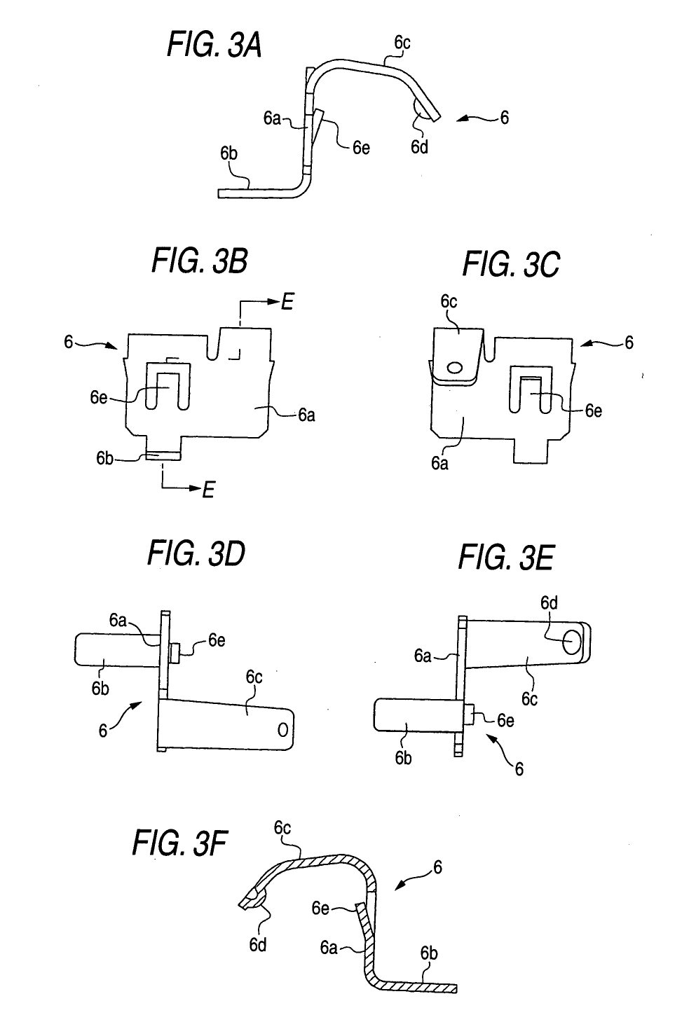

As shown in FIGS. 3A to 3F, the sleeve spring 6 includes a generally square plate-shaped base portion 6a, a terminal 6b projecting from a lower end of that portion (left side portion in FIG. 3B) of the base portion 6a, disposed at the housing body 1, in perpendicular relation to a plane thereof, an arm-shaped spring piece portion 6c projecting from an upper end of that portion (right side portion in FIG. 3B) of the base portion 6a, disposed at the sleeve portion 1b, in a direction opposite to the terminal 6b, the contact portion 6d formed by bulging part of a distal end of the arm-shaped spring piece portion 6c into a semi-spherical shape, and a fixing tongue 6e formed by forming open three-way slits in a predetermined portion of the base portion 6a to provide a generally rectangular portion and then by raising this rectangular portion obliquely upwardly toward the arm-shaped spring piece portion 6c. This sleeve spring 6 is, of course, formed into an integral construction, using an electrically-conductive material.

As shown in FIGS. 3A and 3F, the arm-shaped spring piece portion 6c projects opposite to the terminal 6b, and is bent at a portion thereof, adjacent to its distal end portion, to be inclined downwardly. As describe later and as shown in FIG. 2B, the arm-shaped spring piece portion 6c, while received in a arm receiving groove 1b1 in the sleeve portion 1b, extends from an upper portion of one side portion (upper left side portion) of the sleeve portion 1b to an upper portion of the other side portion (upper right side portion) thereof, and the distal end of this spring piece portion 6c can be inserted into the plug insertion hole 2 through an introduction port 1b2 open to the upper portion of the other side portion (upper right side portion) of the sleeve portion 1b. The contact portion 6d bulges from the lower surface of the distal end of the arm-shaped spring piece portion 6c so as to contact a sleeve electrode of the plug p inserted in the plug insertion hole 2.

As shown in FIGS. 1C,1E,1F,2A,2B and 2D, the base portion 6a of the sleeve spring 6 is inserted in slits 1a1 and 1b3 formed respectively in the left side portions (when the plug insertion hole 2 is viewed from the front side) of the housing body 1a and the sleeve portion 1b of the jack housing 1, thereby fixing the sleeve spring 6 to the jack housing. The slits 1a1 and 1b3 are formed upright in the housing body 1a and the sleeve portion 1b, respectively, and are open at their one sides at a portion of the housing body 1a. The terminal 6b, formed at the lower end of the base portion 6a, projects left from a lower portion of this open region. In this condition, the fixing tongue 6e is pressed against a surface of the housing body 1a within the open region, thereby fixing the base portion 6a to the slits 1a1 and 1b3, as shown in FIGS. 2A and 2D.

Simultaneously when the base portion 6a is thus fixed to the slits 1a1 and 1b3, the arm-shaped spring piece portion 6c is provided on the upper portion of the sleeve portion 1b. On the other hand, as shown in FIGS. 1E and 2B, the arm receiving groove 1b1 is formed in the upper portion of the sleeve portion 1b, and extends from its left side to its right side. The introduction port 1b2, communicating with the plug insertion hole 2, is open to the upper right side portion of the arm receiving groove 1b1. The arm receiving groove 1b1 slants downwardly from its intermediate portion toward the right-side introduction port 1b2. Therefore, the arm-shaped spring piece portion 6c, provided on the upper portion of the sleeve portion 1b as described above, is fitted in the arm receiving groove 1b1, and its distal end portion slightly projects into the plug insertion hole 2 through the introduction port 1b2, and the contact portion 6b, formed on the lower surface of this distal end portion, faces the plug insertion hole 2.

The chip spring 3, the ring spring 4 and the second sleeve spring 5, mounted on the housing body 1a of the jack housing 1, will be described below.

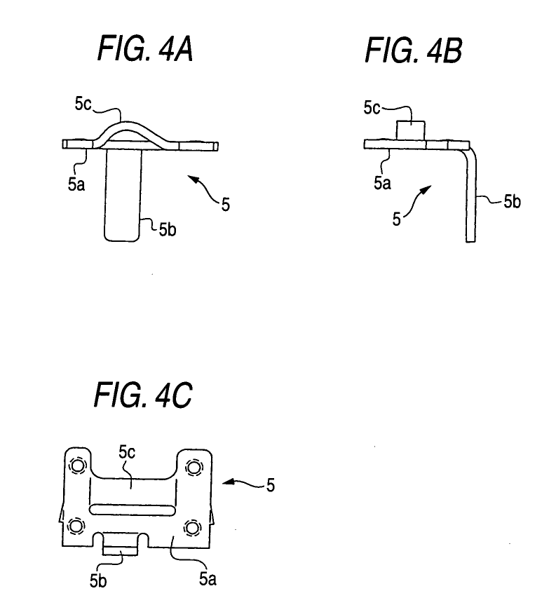

First, the second sleeve spring 5 will be described. As shown in FIG. 4, this second sleeve spring 5 includes a plate-shaped base portion 5a, a terminal 5b projecting perpendicularly outwardly from a lower end (a lower end in FIG. 4C) of the base portion 5a, and the plate-shaped contact portion 5c of an arcuate shape projecting from a central portion of the base portion 5a in a direction opposite to the terminal 5b. This second sleeve spring 5 is formed into an integral construction, using an electrically-conductive material.

As shown in FIGS. 1A, 1D, 1E, 1F and 2A to 2D, the second sleeve spring 5 is provided at the front end portion of the housing body 1a, and the contact portion 5c is disposed in the plug insertion hole 2. This arrangement is achieved by press-fitting the base portion 5a into a slit formed in the right front portion (when the plug insertion hole 2 is viewed from the front side) of the connector housing 1a, with the contact portion 5a disposed in the plug insertion hole 2. In this condition, the terminal 5b projects laterally from the right side of the lower end of the housing body 1a.

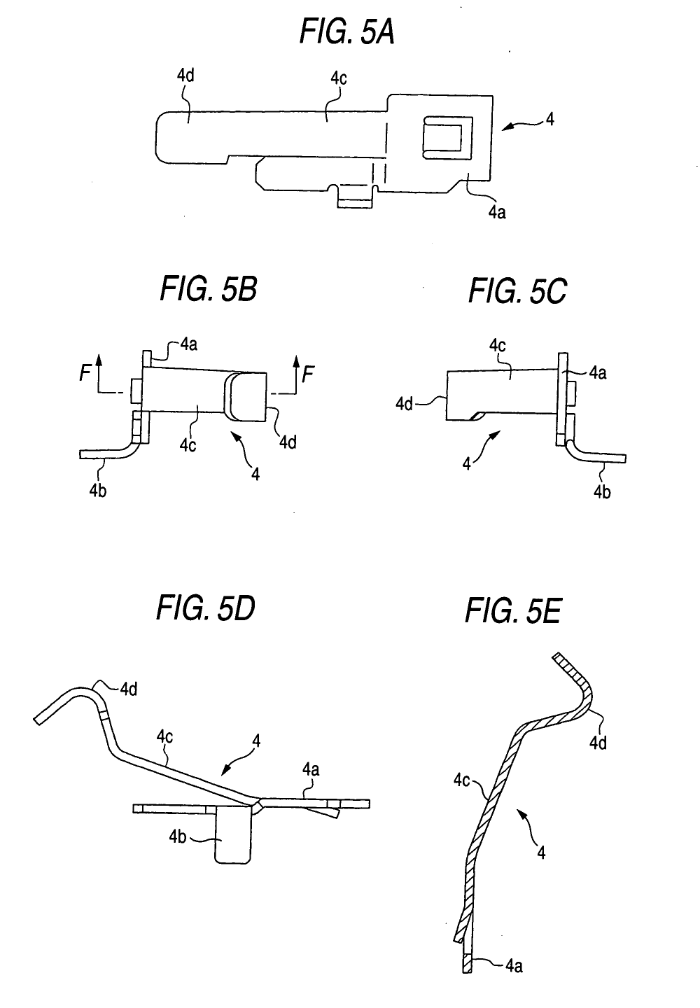

As shown in FIGS. 5A to 5E, the ring spring 4 includes a plate-shaped base portion 4a, a terminal 4b projecting perpendicularly outwardly from a lower end of this base portion, an arm-shaped spring piece portion 4c extending obliquely laterally from an upper portion of one end of the base portion 4a in a direction opposite to the terminal 4b, and the contact portion 4d which is formed at a distal end portion of the spring piece portion 4c, and is curved to bulge in a direction opposite to the terminal 4b. This ring spring is formed into an integral construction, using an electrically-conductive material.

As shown in FIGS. 1A, 1B, 1C, 1E and 1F and FIGS. 2A and 2B, this ring spring 4 is provided at a left side portion of a rear portion of the housing body 1a, and extends to an intermediate portion of the housing body 1a, and the contact portion 4d projects into the plug insertion hole 2. As shown in these Figures, when the base portion 4a is press-fitted in a slit, formed in the left side portion (when the plug insertion hole 2 is viewed from the front side) of the rear portion of the housing body 1a, so that the arm-shaped spring piece portion 4c extends forwardly through a movement space in the housing body 1a, the contact portion 4d projects into the plug insertion hole 2.

As shown in FIG. 2A, a plate-shaped contact piece 7 is provided in the plug insertion hole 2, and is disposed adjacent to the base portion 4a and arm-shaped spring piece portion 4c of the ring spring 4 in parallel relation to the base portion 4a. When the plug p is not inserted in the plug insertion hole 2, a boundary portion of the arm-shaped spring piece portion 4c, disposed immediately adjacent to the contact portion 4d, is held in contact with a contact portion 7a formed at a front end of the plate-shaped contact piece 7. In this condition, when the plug p is inserted, the arm-shaped spring piece portion is pushed outwardly, so that this boundary portion is disengaged from the contact portion 7a. A terminal 7b is formed on and projects laterally from a lower end portion of the plate-shaped contact piece 7.

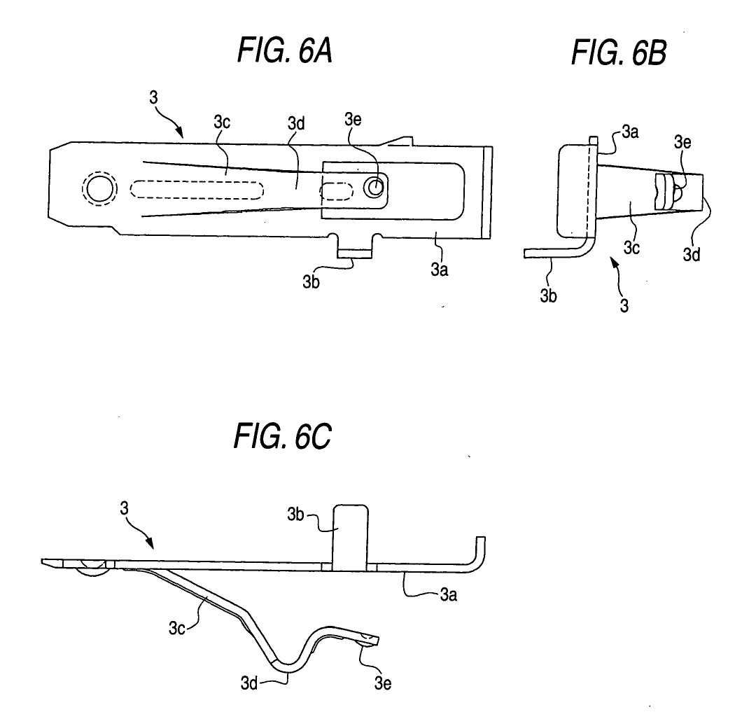

As shown in FIGS. 6A to 6C, the chip spring 3 includes a rectangular base portion 3a, a terminal 3b projecting perpendicularly outwardly from a lower end of this base portion, an arm-shaped spring piece portion 3c extending obliquely laterally from a front end portion of the base portion 3a in a direction opposite to the terminal 3b, the contact portion 3d which is formed at that portion of this spring piece portion disposed adjacent to a distal end portion thereof, and is curved to bulge in a direction opposite to the terminal 3b, and a contact 3e which is formed at the distal end portion of the spring piece portion that is, disposed closer to the distal end thereof than the contact portion 3d is, and bulges into a semi-spherical shape in the same direction as the contact portion 3d.

As shown in FIGS. 1A, 1B, 1D, 1E and 1F and FIGS. 2A to 2C, this chip spring 3 is provided at a right side portion of the housing body 1a extending between the rear and front portions thereof, and the contact portion 3d projects into the plug insertion hole 2. As shown in these Figures, when the base portion 3a is press-fitted in a slit, formed in the right side portion (when the plug insertion hole 2 is viewed from the front side) of the housing body 1a extending between the front and rear portions thereof, so that the arm-shaped spring piece portion 3c extends from the front portion toward the rear portion through the movement space in the housing body 1a, the contact portion 3d, disposed adjacent to the distal end portion of this spring piece portion, projects into the plug insertion hole 2, and the contact 3e, formed at the distal end thereof, is held in contact with a contact portion 8a of a plate-shaped contact piece 8 described later.

As shown in FIG. 2A, the plate-shaped contact piece 8 is provided in the plug insertion hole 2, and faces a rear portion of the base portion 3a of the chip spring 3 in parallel relation to this base portion 3a. When the plug p is not inserted in the plug insertion hole 2, the contact 3e at the distal end portion of the arm-shaped spring piece portion 3c is held in contact with the contact portion 8a of the plate-shaped contact piece 8. In this condition, when the plug p is inserted, the arm-shaped spring piece portion is pushed outwardly, so that the contact 3e is disengaged from the contact portion 8a. A terminal 8b is formed on and projects laterally from a lower end portion of the plate-shaped contact piece 8.

The contact portions 3d, 4d and 5c of the chip spring 3, ring spring 4 and second sleeve spring 5 are so positioned that when the plug p is fully inserted a predetermined depth into the plug insertion hole 2 in the jack housing 1, these contact portions 3d, 4d and 5c can be press-contacted with corresponding chip electrode, ring electrode and second sleeve electrode, respectively. Similarly, the contact portion 6d of the sleeve spring 6 is so positioned as to be press-contacted with the sleeve electrode of the inserted plug p.

Therefore, in the four-pole jack of this embodiment, when the corresponding four-pole plug p is inserted into the plug insertion hole 2 in this jack, this plug advances in this plug insertion hole while retracting the projected contact portion 3d and the other protected contact portions outwardly sequentially by the chip electrode disposed at the distal end of this plug and the following electrodes. Then, when the plug is fully inserted into the predetermined depth, the chip electrode disposed at the distal end of the plug contacts the contact portion 3d of the chip spring 3, and the secondly-disposed ring electrode contacts the contact portion 4d of the ring spring 4, and the thirdly-disposed second sleeve electrode contacts the contact portion 5c of the second sleeve spring 5, and the sleeve electrode disposed at the rear end portion of the plug contacts the contact portion 6d of the sleeve spring 6, so that each mating pair of electrode and contact portion are electrically connected together.

At this time, the contact portion 3d of the chip spring 3 is pushed outwardly by the plug p to be retracted, so that its contact 3e is disengaged from the contact portion 8a at the front end of the plate-shaped contact piece 8, and therefore the electrical connection therebetween is canceled. Similarly, the contact portion 4d of the ring spring 4 is pushed outwardly by the plug to be retracted, so that the boundary portion of the arm-shaped spring piece portion 4c, disposed immediately adjacent to the contact portion 4d, is disengaged from the contact portion 7a of the plate-shaped contact piece 7, and therefore the electrical connection therebetween is canceled.

Thus, the four-pole jack can satisfactorily effect the electrical connections and the cancellation of the electrical connections which are the basic functions of the jack. Particularly, although most of the important portions of the sleeve spring 6 are provided at the sleeve portion 1b of the jack housing 1, this sleeve spring can be smoothly and positively electrically connected to the sleeve electrode of the plug p.

When the plug p is inserted into the plug insertion hole 2, the contact portion 6d of the sleeve spring 6 is pushed outwardly by the sleeve electrode of the plug p to be retracted. However, the contact portion 6d is formed at the distal end of the arm-shaped spring piece portion 6c extending from the base portion 6a, and this arm-shaped spring piece portion 6c has a sufficient length to extend from the upper portion of the one side portion of the sleeve portion 1b to the upper portion of the other side portion thereof, and therefore the above retracting action can be resiliently carried out satisfactorily. And besides, this sleeve spring 6 is formed of the spring material having a suitable resiliency, and the contact portion 6d can contact the sleeve electrode of the plug p with a suitable spring pressure.

When the plug p is inserted into the plug insertion hole 2, the plug p retracts the contact portion 6d as described above, and at this time the arm-shaped spring piece portion 6c is also retracted outwardly. When the plug p is removed from the plug insertion hole, the arm-shaped spring piece portion is restored because of its own spring force, thereby returning the contact portion 6d into its original position. Although the arm-shaped spring piece portion 6c is thus slightly moved radially outwardly and inwardly of the sleeve portion 2, this movement is small, and besides the arm-shaped spring piece portion 6c is received in the arm receiving groove 1b formed in the sleeve portion 2, and therefore there is no fear that the arm-shaped spring piece portion interferes with external nearby articles because of this movement.

In the four-pole jack of this embodiment, the arm-shaped spring piece portion 6c of the sleeve spring 6, as well the contact portion 6d at the distal end thereof, is provided at the sleeve portion 1b of the jack housing 1, so that the number of the elements, provided at the housing body 1a, is reduced. Therefore, the dimension of the housing body 1a in the direction of its thickness or in the direction of its width is reduced, so that the compact design can be achieved. And besides, the arm-shaped spring piece portion 6c of the sleeve spring 6 is received in the arm receiving groove 1b1 formed in the upper portion of the sleeve portion 1b in the peripheral direction, and therefore the more compact and thinner design of the jack housing 1 can be achieved.

1. A multi-pole jack comprising:
a body;
a sleeve portion that has a plug insertion and is disposed at a distal end of the body;
a sleeve spring that includes a base portion that is provided at a side portion of a front portion of the body and a side portion of the sleeve portion, an arm-shaped spring piece portion that projects from a portion of the base portion disposed at the sleeve portion and extends to an upper portion of an opposite side portion of the sleeve portion, and a contact portion that is formed at a distal end of the arm-shaped spring piece portion and faces the plug insertion hole through the upper portion of the opposite side portion so as to contact with a electrode of a plug inserted in the plug insertion hole; and
contact pieces that are disposed at the body so as to contact with other electrodes of the plug inserted in the plug insertion hole.

2. A multi-pole jack according to claim 1, wherein the arm-shaped spring piece portion extends from the base portion through an arm receiving groove that is formed from an upper portion of the sleeve portion to the upper portion of the opposite side portion of the sleeve portion in a peripheral direction of the sleeve portion and the contact portion, formed at the distal end of the arm-shaped spring piece portion, projects into the plug insertion hole through an introduction port open to the upper portion of the opposite side portion in a manner that the contact portion can be resiliently retracted.

3. A multi-pole jack comprising:
a body;
a sleeve portion that has a plug insertion hole and is disposed at a distal end of the body; and
a sleeve spring that includes a base portion that extends between the body and the sleeve portion, an arm-shaped spring piece portion that projects from a portion of the base portion disposed at the sleeve portion and extends in a peripheral direction of the sleeve portion, a contact portion that faces the plug insertion hole so as to contact with a plug inserted in the plug insertion hole in an insertion direction and is formed at a distal end of the arm-shaped spring piece portion.

4. A multi-pole jack according to claim 3, wherein the sleeve spring includes a terminal that projects from a portion of the base portion disposed at the body in a direction substantially perpendicular to the insertion direction.

5. A multi-pole jack according to claim 4, wherein the terminal is projected from a portion of the body adjacent to the sleeve portion.

6. A multi-pole jack according to claim 3, wherein the arm-shaped spring piece portion is disposed in an arm receiving groove formed at the sleeve portion.

7. A multi-pole jack according to claim 3, wherein an introduction port is opposed to a portion of the sleeve portion at which the base portion is disposed, and the contact portion faces the plug insertion hole through the introduction port.

8. A multi-pole jack according to claim 3, wherein the contact portion has a semi-spherical projection and bulges toward a sleeve electrode of the plug.

9. A multi-pole jack according to claim 3, wherein the contact portion can be resiliently retracted.

10. A multi-pole jack according to claim 3 further comprising contact pieces that are disposed at the body so as to contact with other electrodes of the inserted plug.

11. A multi-pole jack according to claim 3 further comprising a second sleeve spring disposed at the body so that the portion of the base portion disposed at the body is aligned to the second sleeve spring in the peripheral direction.
